(19) United States
(12) Patent Application Publication
(10) Pub. No.: US 2016/0250687 A1
(43) Pub. Date: Sep. 1, 2016

(54) REFRACTORY CERAMIC NOZZLE

(71) Applicant: REFRACTORY INTELLECTUAL PROPERTY GMBH & CO. KG, Wien (AT)

(72) Inventors: Alan Dick, Bellshill STRATHCLYDE (GB); Gernot Hackl, Trofaiach (AT)

(21) Appl. No.: 14/903,846

(22) PCT Filed: May 22, 2014
(86) PCT No.: PCT/EP2014/060515

§ 371 Date: Jan. 27, 2016

(30) Foreign Application Priority Data
Aug. 5, 2013 (EP) 13179295.4

(51) Int. Cl. B22D 41/50; F27D 3/14

(52) U.S. Cl. CPC B22D 41/507; F27D 3/14

(57) ABSTRACT

The invention relates to a refractory ceramic nozzle for metallurgical applications. The term “nozzle” includes a submerged entry nozzle (also called SEN or casting nozzle) as used in a continuous casting process for producing steel. Prior art and the invention will be described hereinafter with respect to such a SEN but without limiting the scope of the invention.

The invention relates to a refractory ceramic nozzle for metallurgical applications. The term “nozzle” includes a submerged entry nozzle (also called SEN or casting nozzle) as used in a continuous casting process for producing steel. Prior art and the invention will be described hereinafter with respect to such a SEN but without limiting the scope of the invention.

During metal casting the molten metal is transferred from a so called ladle (German: Pfanne) into a tundish (German: Verteiler) and from there via corresponding tundish outlets into associated moulds.

The melt transfer from the tundish into a mould is achieved by a nozzle which is arranged in a vertical use position and which typically provides the following features:

a generally tube like shape, defining a central longitudinal nozzle axis, and comprising an inner nozzle wall, surrounding a flow-through channel, which extends along an axial length between an inlet opening at a first nozzle end, being an upper end in a use position of the nozzle, and at least one outlet opening at a second nozzle end, being a lower end in the use position, to allow a continuous flow stream of a molten metal from its inlet opening along said flow-through channel via said outlet opening(s) into an associated molten metal bath.

To improve the general performance of such a nozzle EP 2226141 B1 discloses a nozzle with a perturbation in the form of a recessed channel in the inner surface of the nozzle wall of at least one outlet opening so as to produce a fluid flow which follows the shape of the lateral outlet openings.

U.S. Pat. No. 3,991,815 A discloses a nozzle design to improve a controlled flow at a separate bottom opening beneath lateral outlet openings.

A major problem during use of these known nozzles, i.e. during casting a metal melt, is the formation of clogs at the inner nozzle wall, bores and/or ports, the so-called “clogging effect”. Clogging is caused—inter alia—by
transport of oxides, present in the metal melt, to the inner nozzle wall where they stick to the wall
chemical reactions between the melt and the refractory material, again forming agglomerates onto the inner nozzle wall
metal melt which solidifies at the inner nozzle wall.

Such clogs, agglomerates or cakings (german: Anbackungen) change the inner cross section of the flow-through channel and/ or the nozzle outlet areas and insofar the nozzle flow pattern in an uncontrolled manner.

Different attempts have been made to reduce clogging, for example by
using antioxidants to remove the metal oxides from the melt [US 2007/0045884 A1]
providing spiral grooves along the inner wall of the flow-through channel [JP03673372132]

without achieving the required results.

Therefore it is an object of the invention to provide a nozzle with improved anti-clogging behavior.

While the proposal of US 2007/0045884 A1 is based on chemical changes within the casting system the disclosure according to JP03673372B2 is based on structural changes of the nozzle to initiate a stirring effect to the metal flow.

Intensive investigations, including water models and computer simulations, have been made to study the flow behavior of the melt and/or corresponding clogging effects.

During such trials it was found that stirring of the metal melt by said grooves does not effectively reduce or avoid clogging as said grooves, offset by an angle of ca. 180° in case of two grooves or ca. 120° in case of three grooves, do not vary the flow pattern characteristically over the axial length of the nozzle.

The invention is based on the finding that clogging may be reduced to great extent by inducing turbulences within the melt stream at the inner wall surface and thus additional shear stresses between melt and wall surface.

This is achieved by providing junctions (crossing areas) between at least two groove like depressions along the inner nozzle wall. Contrary to JP03673372B2 the new nozzle design is characterized by spiraled (helically fashioned) grooves of different (opposing) orientation in order to provide these crossing areas/junctions.

In other words: The new design urges the metal stream to split up/divide into different partial streams of different orientation (at least one clockwise, at least one anti-clockwise), for example:
a central stream, substantially coaxial to the central longitudinal axis of the nozzle
a first spiral stream—in a first direction, clockwise—along a first groove
a second spiral stream—in a second direction, anti-clockwise—along a second groove

wherein the first and second spiral streams cross each other at multiple junctions, depending on their respective lengths and inclinations (slope, german: Steigungsmaβ).

This general concept may be transferred analogously to a nozzle design with three, four or even more grooves in the inner nozzle wall, thus increasing the number of junctions.

Although the invention follows the idea of grooves along the inner wall surface of the nozzle according to JP 03673372 B2 it is based on a different structural approach and leads to a different flow behavior of the melt. The crossing grooves are responsible for a considerable formation of wall near turbulences within the melt stream, and these turbulences are responsible for a considerable decrease in clogging, without adverse effects on the general melt stream.

While similar turbulences could also be achieved by replacing the said grooves by spiral fins protruding from the inner wall surface, no considerable reduction in clogging was achievable by these means because of the formation of wall near chambers between opposing fin sections providing unfavorable dead zones.

In its most general embodiment the invention may be defined as follows:

Refractory ceramic nozzle featuring:
a generally tube like shape, defining a central longitudinal nozzles axis (A) and comprising an inner nozzle wall surrounding a flow-through channel, which extends along an axial length (L) between an inlet opening at a first nozzle end, being an upper end in a use position of the nozzle, and at least one outlet opening at a second nozzle end, being a lower end in the use position, to allow a continuous flow stream of a molten metal from its inlet opening along said flow-through channel via said outlet opening into an associated molten metal bath, wherein at least two grooves being provided along the inner nozzle wall, including
a first groove provided along at least part of the axial length of the flow-through channel within said inner nozzle wall in a spiral fashion,
a second groove provided along at least part of the axial length of the flow-through channel within said inner nozzle wall in a spiral fashion,
first groove and second groove cross each other at multiple junctions.

The grooves extend along the inner surface of the nozzle wall, which inner surface in many cases will be of circular cross section but may have any other design as well.

Insofar the term “spiral” does not necessarily mean a cylindrical spiral/helix but includes all 3-dimensional shapes wherein the respective groove encircles a 3-dimensional space, namely the flow through channel of the nozzle, along which the metal flows from the inlet port (inlet opening) to one or more outlet ports (outlet openings). Insofar “spiral” includes i.a. oval shapes, rectangular shapes as well as polygonal shapes.

The number of junctions depends on the length and slope of the respective grooves. The following are possible options to design the nozzle which may be realized individually or in arbitrary combinations if not tautologic or excluded:
at least two grooves have a helix angle of more than 20° and less than 80° with respect to the central longitudinal nozzle axis (A).
at least one of said grooves has a helix angle of more than 30° with respect to the central longitudinal nozzle axis (A).
at least one of said grooves has a helix angle of more than 40° with respect to the central longitudinal nozzle axis (A).
at least one of said grooves has a helix angle of less than 70° with respect to the central longitudinal nozzle axis (A).
at least one of said grooves has a helix angle of less than 55° with respect to the central longitudinal nozzle axis (A).
at least the first groove and second groove have the same helix angle, wherein this embodiment includes tolerances of ±10° to an average angle [(first angle+second angle): 2].
first groove and second groove are offset by 180° ±30° along a plane (P) perpendicular to the central longitudinal nozzle axis (A). In case of a 180° offset the two grooves may run in a mirror inverted fashion to a plane comprising the central longitudinal axis.
at least the first groove and second groove extend along the same axial length of the flow-through channel.
in an embodiment with three grooves the grooves are offset by 120° to each other.
at least one of said grooves starts at a distance (d) to the inlet opening of the nozzle.
at least one of said grooves ends at a distance (d) to the outlet opening of the nozzle.
at least one of said grooves has a semi-circular cross section. Other cross sectional shapes are for example: oval, rectangular, involute like.
with a groove diameter between 3 and 15 mm
with a groove diameter larger 5 mm and/or smaller 10 mm
at least the said first groove and said second groove merge into a common ring-shaped groove at least at one of their ends.

The production of a nozzle including the last mentioned embodiment may be achieved as follows:

The nozzle is produced in a conventional hydraulic press or an isostatically operated press (as known to the skilled person) with the proviso that the inner mandrel (to keep the flow through channel area open) has a spiral/helix like structure on its outer surface (protruding from adjacent areas) to form the groove like depressions during compression molding. In other words: The protrusions are the male part, the depressions the female part during compression. The mandrel is a multi part mandrel so that it can be extracted from the nozzle interior after the compression step.

Another option to form the said grooves is to put a corresponding detachable template onto the outer surface of the mandrel which forms the grooves during the compression step. The template material must be strong enough to give the grooves the desired shape and combustible so that it may be burnt off after the moulding process, thereby exposing the grooves.

Further features of the invention derive from the features of the sub-claims and the other application documents.

The invention will now be described in more detail with respect to the attached drawing schematically representing one possible embodiment of the invention, wherein

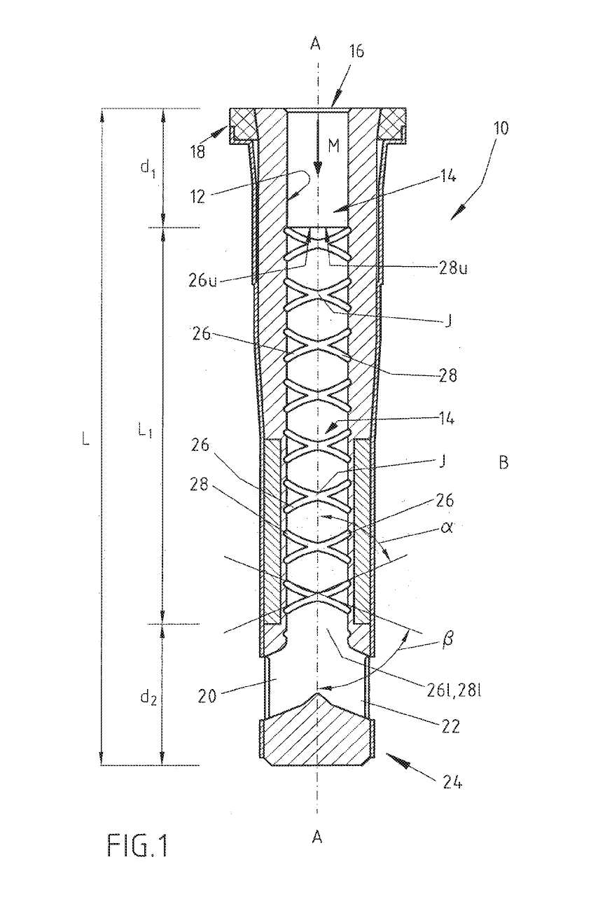

FIG. 1 shows a 2 dimensional vertical cross sectional view of a nozzle according to the invention

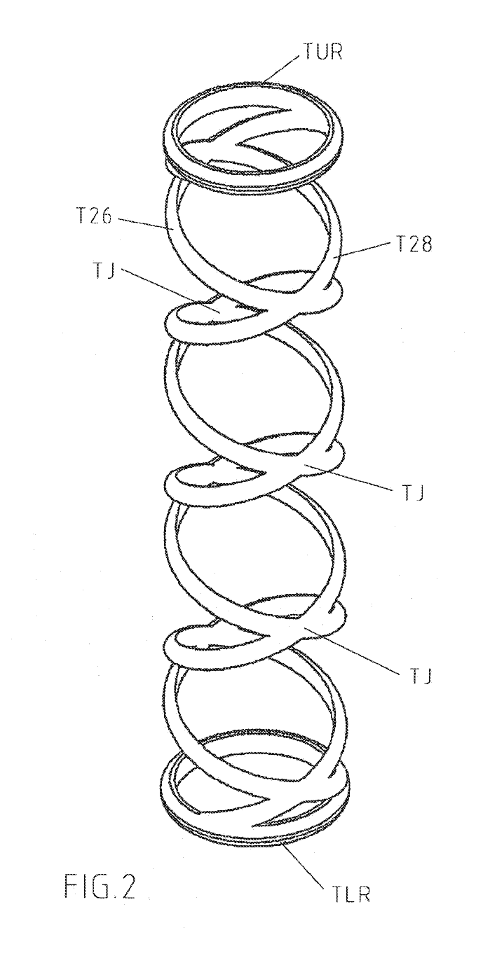

FIG. 2 shows a template to provide the grooves on the surface of the inner nozzle wall

The nozzle according to FIG. 1 is a refractory ceramic SEN (submerged entry nozzle 10) as explained above featuring:
a generally tube like shape, defining a central longitudinal nozzles axis A and comprising an inner nozzle wall 12 surrounding a flow-through channel 14, which extends along an axial length L between an inlet opening 16 at a first nozzle end 18, being an upper end in a use position of the nozzle 10, and two lateral outlet openings 20, 22 at a second nozzle end 24, being a lower end in the (shown) use position, to allow a continuous flow stream of a molten metal (arrow M) from its inlet opening 16 along said flow-through channel 14 via said lateral outlet openings 20, 22 into an associated molten metal bath B,
a first groove 26 extends from an upper end 26u—at a distance (d1) to the inlet opening 16—along part (length L1) of the axial length (L) of the flow-through channel 14 within said inner nozzle wall 12 in a spiral fashion up to a lower end 26l at a distance (d2) to the lower end of outlet openings 20,22,
a second groove 28 extends from an upper end 28u—at the same distance (d1) to the inlet opening 16—along part (same length L1) of the axial length (L) of the flow-through channel 14 within said inner nozzle wall 12 in a spiral fashion up to a lower end 28l at the same distance (d2) to the lower end of outlet openings 20,22, wherein
first groove 26 and second groove 28 cross each other at multiple junctions J.

In the disclosed embodiment first groove 26 and second groove 28 are offset by 180° so that the symmetrical profile according to FIG. 1 is achieved as well as a rotationally symmetric but opposing flow pattern of the metal melt along the two groove sections with collision zones at the junctions disclosed.

While one partial metal stream is running clockwise along one of said grooves 26,28 from inlet opening 26 to outlet port 28 another partial stream along said second groove 28,26 turns anti-clockwise; the central stream (around central longitudinal axis A) is not influenced seriously by said additional helix flows.

This leads to the desired shear stress profile between inner nozzle wall 12 and metal melt M in the vicinity of said grooves 26,28 and includes repeating turbulences at each junction which are effective not only in the specific junction (crossing) area but as well in adjacent sections.

This is the decisive factor for a considerable reduction in clogging at the inner surface wall 12.

The embodiment shown is further characterized by the following features:
groove shapes: semi circular
groove diameter: 7 mm
helix angle a of groove 28 to the central longitudinal axis A: 45°
helix angle β of groove 26 to the central longitudinal axis A: 45°
material of nozzle wall : alumina-graphite (60 M-% Al₂O₃, 10 M-%, SiO₂, 30 M-.% C).

FIG. 2 represents a template T made of a low temperature melting material, here: a bismuth alloy with two strings T26 and T28, both arranged in a helical fashion and linked with each other at junctions TJ and upper and lower rings TUR, TLR to provide a suitable stiffness when said template T is arranged onto a corresponding mandrel and set into a press mold.

The said strings T26, T28 provide the corresponding grooves 26, 28 during compression moulding as described in connection with FIG. 1 and are melted off after the mandrel has been withdrawn from the ceramic nozzle and the nozzle has been withdrawn from the mould.

1. Refractory ceramic nozzle featuring:
a generally tube like shape, defining a central longitudinal nozzle axis (A) and comprising an inner nozzle wall (12) surrounding a flow-through channel (14), which extends along an axial length (L) between an inlet opening (16) at a first nozzle end (18), being an upper end in a use position of the nozzle, and at least one outlet opening (20,22) at a second nozzle end (24), being a lower end in the use position, to allow a continuous flow stream of a molten metal from its inlet opening (16) along said flow-through channel (14) via said outlet opening (20,22) into an associated molten metal bath (B), wherein at least two grooves (26, 28) being provided along the inner nozzle wall (12), including
a first groove (26) provided along at least part of the axial length (L) of the flow-through channel (14) within said inner nozzle wall (12) in a spiral fashion,
a second groove (28) provided along at least part of the axial length (L) of the flow-through channel (14) within said inner nozzle wall (12) in a spiral fashion,
first groove (26) and second groove (28) cross each other at multiple junctions (J).

2. Nozzle according to claim 1, wherein at least two grooves (26, 28) each have a helix angle (α, β) of more than 20° and less than 80° with respect to the central longitudinal nozzle axis (A).

3. Nozzle according to claim 1, wherein at least one of said grooves (26, 28) has a helix angle (α, β) of more than 30° with respect to the central longitudinal nozzle axis (A).

4. Nozzle according to claim 1, wherein at least one of said grooves (26, 28) has a helix angle (α, β) of more than 40° with respect to the central longitudinal nozzle axis (A).

5. Nozzle according to claim 1, wherein at least one of said grooves (26, 28) has a helix angle (α, β) of less than 70° with respect to the central longitudinal nozzle axis (A).

6. Nozzle according to claim 1, wherein at least one of said grooves (26, 28) has a helix angle (α, β) of less than 55° with respect to the central longitudinal nozzle axis (A).

7. Nozzle according to claim 1, wherein at least the first groove (26) and second groove (28) have the same helix angle (α, β).

8. Nozzle according to claim 1, wherein first groove (26) and second groove (28) are offset by 180°±30° along a plane (P) perpendicular to the central longitudinal nozzle axis (A).

9. Nozzle according to claim 1, wherein at least the first groove (26) and second groove (28) extend along the same axial length (L1) of the flow-through channel (14).

10. Nozzle according to claim 1, wherein at least one of said grooves (26, 28) starts at a distance (d1) to the inlet opening (16) of the nozzle (10).

11. Nozzle according to claim 1, wherein at least one of said grooves (26, 28) ends at a distance (d2) to the outlet opening (20,22) of the nozzle (10).

12. Nozzle according to claim 1, wherein at least one of said grooves (26, 28) has a semi-circular cross section.

13. Nozzle according to claim 12 with a groove diameter between 3 and 15 mm.

14. Nozzle according to claim 12 with a groove diameter between 5 and 10 mm.

15. Nozzle according to claim 1 wherein at least the said first groove (26) and said second groove (28) merge into a common groove at least at one of their ends.
